(19) United States
(12) Patent Application Publication
(10) Pub. No.: US 2013/0190429 A1
(43) Pub. Date: Jul. 25, 2013

(54) Biodegradable Hydrophobic Cellulosic Substrates And Methods For Their Production Using Reactive Silanes

(71) Applicants: Kevin Dale Lewis, Sanford, MI (US); James Habermehl, Midland, MI (US); William James Schulz, JR., Midland, MI (US)

(72) Inventors: Kevin Dale Lewis, Sanford, MI (US); James Habermehl, Midland, MI (US); William James Schulz, JR., Midland, MI (US)

(73) Assignee: Dow Corning Corporation, MIDLAND, MI (US)

(21) Appl. No.: 13/877,466

(22) PCT Filed: May 16, 2011
(86) PCT No.: PCT/US2011/036579

§ 371 Date: Apr. 3, 2013

Related U.S. Application Data
(60) Provisional application No. 61/390,643, filed on Oct. 7, 2010.

(51) Int. Cl. B05D 3/10

(52) U.S. Cl. CPC B05D 3/107
USPC 524/35; 427/331; 427/341

(57) ABSTRACT

A method for rendering a substrate hydrophobic while maintaining its biodegradability includes treating the substrate with a reactive silane such that the reactive silane forms a resin in the interstitial spaces of the substrate. The method parameters are controlled such that the resulting hydrophobic cellulosic substrate is compostable.

### CROSS REFERENCE TO RELATED APPLICATIONS

None.

### TECHNICAL FIELD

A biodegradable, hydrophobic substrate, and a method for rendering the substrate hydrophobic is disclosed. A reactive silane is used in the method.

### BACKGROUND

Cellulosic substrates such as paper and cardboard (such as corrugated fiberboard, paperboard, display board, or card stock) products encounter various environmental conditions based on their intended use. For example, cardboard is often used as packaging material for shipping and/or storing products and must provide a durable enclosure that protects its contents. Some such environmental conditions these packaging materials may face are water through rain, temperature variations which may promote condensation, flooding, snow, ice, frost, hail or any other form of moisture. Other products include disposable food service articles, which are commonly made from paper or paperboard. These cellulosic substrates also face moist environmental conditions, e.g., vapors and liquids from the foods and beverages they come in contact with. Water in its various forms may threaten a cellulosic substrate by degrading its chemical structure through hydrolysis and cleavage of the cellulose chains and/or breaking down its physical structure via irreversibly interfering with the hydrogen bonding between the chains, thus decreasing its performance in its intended use. When exposed to water, other aqueous fluids, or significant amounts of water vapor, items such as paper and cardboard may become soft, losing form-stability and becoming susceptible to puncture (e.g., during shipping of packaging materials or by cutlery such as knives and forks used on disposable food service articles).

Manufacturers may address the problem of the moisture-susceptibility of disposable food service articles by not using the disposable food service articles in moist environments. This approach avoids the problem simply by marketing their disposable food service articles for uses in which aqueous fluids or vapor are not present (e.g., dry or deep-fried items). However, this approach greatly limits the potential markets for these articles, since many food products (1) are aqueous (e.g., beverages, soups), (2) include an aqueous phase (e.g., thin sauces, vegetables heated in water), or (3) give off water vapor as they cool (e.g., rice and other starchy foods, hot sandwiches, etc.).

Another way of preserving cellulosic substrates is to prevent the interaction of water with the cellulosic substrate. For example, water-resistant coatings (e.g., polymeric water-proofing materials such as wax or polyethylene) may be applied to the surfaces of the cellulosic substrates to prevent water from contacting the cellulosic substrates directly. This approach essentially forms a laminated structure in which a water-sensitive core is sandwiched between layers of a water-resistant material. Many coatings, however, are costly to obtain and difficult to apply, thus increasing manufacturing cost and complexity and reducing the percentage of acceptable finished products. Furthermore, coatings can degrade or become mechanically compromised and become less effective over time. Coatings also have the inherent weakness of poorly treated substrate edges. Even if the edges can be treated to impart hydrophobicity to the entire substrate, any rips, tears, wrinkles, or folds in the treated substrate can result in the exposure of non-treated surfaces that are easily wetted and can allow wicking of water into the bulk of the substrate.

Furthermore, certain coatings and other known hydrophobing treatments for cellulosic substrates may also render the substrates not biodegradable. Therefore, it would be desirable to provide a method for rendering cellulosic substrates hydrophobic while maintaining their biodegradability.

### SUMMARY

A method for rendering a substrate hydrophobic while maintaining its biodegradability is disclosed. The method includes penetrating the substrate with a reactive silane and forming a resin from the reactive silane.

### DETAILED DESCRIPTION

All amounts, ratios, and percentages described herein are by weight unless otherwise indicated. The articles ‘a’, ‘an’, and ‘the’ each refer to one or more, unless otherwise indicated by the context of specification. The disclosure of ranges includes the range itself and also anything subsumed therein, as well as endpoints. For example, disclosure of a range of 2.0 to 4.0 includes not only the range of 2.0 to 4.0, but also 2.1, 2.3, 3.4, 3.5, and 4.0 individually, as well as any other number subsumed in the range.

Furthermore, disclosure of a range of, for example, 2.0 to 4.0 includes the subsets of, for example, 2.1 to 3.5, 2.3 to 3.4, 2.6 to 3.7, and 3.8 to 4.0, as well as any other subset subsumed in the range. Similarly, the disclosure of Markush groups includes the entire group and also any individual members and subgroups subsumed therein. For example, disclosure of the Markush group a hydrogen atom, an alkyl group, an aryl group, an aralkyl group, or an alkaryl group includes the member alkyl individually; the subgroup alkyl and aryl; and any other individual member and subgroup subsumed therein.

The substrates useful in the method described herein are biodegradable. For purposes of this application, the terms ‘compostable,’ and ‘compostability’ encompass factors such as biodegradability, disintegration, and ecotoxicity. The terms ‘biodegradable,’ ‘biodegradability,’ and variants thereof refer to the nature of the material to be broken down by microorganisms. Biodegradable means a substrate breaks down through the action of a microorganism, such as a bacterium, fungus, enzyme, and/or virus over a period of time. The term ‘disintegration,’ disintegrate,' and variants thereof refer to the extent to which the material breaks down and falls apart. Ecotoxicity testing determines whether the material after composting shows any inhibition on plant growth or the survival of soil or other fauna. Biodegradability and compostability may be measured by visually inspecting a substrate that has been exposed to a biological inoculum (such as a bacterium, fungus, enzyme, and/or virus) to monitor for degradation. Alternatively, the biodegradable substrate passes ASTM Standard D6400; and alternatively the biodegradable substrate passes ASTM Standard D6868-03. In general, rate of compostability and/or biodegradability may be increased by maximizing surface area to volume ratio of each substrate. For example, surface area/volume ratio may be at least 10, alternatively at least 17. Alternatively, surface area/ volume ratio may be at least 33. Without wishing to be bound by theory, it is thought that a surface area/ volume ratio of at least 33 will allow the substrate to pass the test for biodegradability in ASTM Standard D6868-03. For purposes of this application, the terms ‘hydrophobic’ and ‘hydrophobicity,’ and variants thereof, refer to the water resistance of a substrate. Hydrophobicity may be measured according to the Cobb test set forth in Reference Example 2, below. The substrates treated by the method described herein may also be inherently recyclable. The substrates may also be repulpable, e.g., the hydrophobic substrate prepared by the method described herein may be reduced to pulp for use in making paper. The substrates may also be repurposeable.

In the method described herein, the term ‘reactive’ means that the silane is capable of forming a resin in the interstitial spaces within the substrate upon exposure to —OH groups in the substrate and/or ambient moisture.

A substrate can be rendered hydrophobic by treating the substrate with a reactive silane. The reactive silane may have formula (I): R¹ₐSi(XR²b)(₄₋ₐ)_{,} where each R¹ is independently a monovalent hydrocarbon group; each X is independently selected from a hydrogen atom, an oxygen atom, a selenium atom, a nitrogen atom, a sulfur atom, a carbon atom, and a phosphorus atom, each R² is independently a monovalent organic group, subscript a has a value ranging from 0 to 3, and subscript b has a value matching a remaining valence of group X. Subscript b may have an average value ranging from 0 to 4.

The value of subscript b depends on the valence of atom X. In formula (I) above, when X is a monovalent atom such as a hydrogen atom, then subscript b is 0. Alternatively, when X is a divalent atom, such as an oxygen atom, then subscript b is 1, e.g., the oxygen atom is covalently bonded to the silicon atom and the remaining valence is 1, and the oxygen atom is covalently bonded to one other atom in a group R². Alternatively, when X is a trivalent atom, such as nitrogen, then subscript b is 2, e.g., the nitrogen atom is covalently bonded to the silicon atom and the remaining valence is 2, so two groups R² can each have one atom covalently bonded to the nitrogen atom. Phosphorus may be trivalent (in which case b is 2). Alternatively, X may be a pentavalent phosphorus atom (in which case b is 4).

Alternatively, the reactive silane may have a cyclic group including silicon. Such a reactive silane may have formula (II):

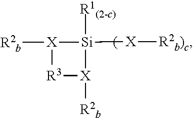

where R¹, R², X, and subscript b are as described above, each R³ is independently a divalent organic group, and subscript c is 0, 1, or 2.

Alternatively, the reactive silane may have two cyclic groups including silicon. Such a reactive silane may have formula (III):

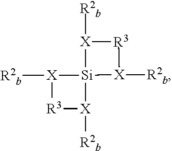

where R², R³, X, and subscript b are as described above. Where X is bonded in a cyclic group, then the value subscript b will change as compared to the value for b in formula (I). For example, in formula (III) when X is an oxygen atom, then b is 0. When X is a nitrogen atom, then b is 1 e.g., the nitrogen atom is covalently bonded to the silicon atom and covalently bonded to group R³, the remaining valence is 1, and the nitrogen atom is covalently bonded to an atom in one group R².

The reactive silane can be applied in any manner such that the reactive silane penetrates the substrate and produces a resin in the interstitial spaces of the substrate (the volume, as well as the surface, of the substrate is rendered hydrophobic). In addition, by varying the amount and the type of the reactive silane, the physical properties of the substrate may be altered. All or a portion of the volume may be rendered hydrophobic. Alternatively, the entire volume of the substrate may be rendered hydrophobic.

Suitable biodegradable substrates for use herein may be cellulosic substrates. Cellulosic substrates are substrates that substantially comprise the polymeric organic compound cellulose having the formula (C₆H₁₀O₅)ₙ where n is any integer. Cellulosic substrates possess
OH functionality, contain water, and optionally other ingredients that may react with the reactive silane compound, such as lignin. Lignin is a polymer that results from the copolymerization of a mixture of monolignols such as p-coumaryl alcohol, coniferyl alcohol, and/or sinapyl alcohol. This polymer has residual —OH functionality with which the reactive silane can react. Examples of suitable substrates include, but are not limited to, paper, wood and wood products, cardboard, wallboard, textiles, starches, cotton, wool, other natural fibers, or biodegradable composites derived there from. Depending on the substrate's intended application and manufacturing process, the substrate can comprise sizing agents and/or additional additives or agents to alter its physical properties or assist in the manufacturing process. Exemplary sizing agents include starch, rosin, alkyl ketene dimer, alkenyl succinic acid anhydride, styrene maleic anhydride, glue, gelatin, modified celluloses, synthetic resins, latexes and waxes. Other exemplary additives and agents include bleaching additives (such as chlorine dioxide, oxygen, ozone and hydrogen peroxide), wet strength agents, dry strength agents, fluorescent whitening agents, calcium carbonate, optical brightening agents, antimicrobial agents, dyes, retention aids (such as anionic polyacrylamide and polydiallydimethylammonium chloride, drainage aids (such as high molecular weight cationic acrylamide copolymers, bentonite and colloidal silicas), biocides, fungicides, slimacides, talc and clay and other substrate modifiers such as organic amines including triethylamine and benzylamine. It should be appreciated that other sizing agents and additional additives or agents not listed explicitly herein may alternatively be applied, alone or in combination. For example, where the substrate comprises paper, the paper can also comprise or have undergone bleaching to whiten the paper, starching or other sizing operation to stiffen the paper, clay coating to provide a printable surface, or other alternative treatments to modify or adjust its properties. Furthermore, substrates such as paper can comprise virgin fibers, wherein the paper is created for the first time from non-recycled cellulose compounds, recycled fibers, wherein the paper is created from previously used cellulosic materials, or combinations thereof.

The substrate may vary in thickness and/or weight depending on the type and dimensions of the substrate. The thickness of the substrate can range from less than 1 mil (where 1 mil =0.001 inches =0.0254 millimeters (mm)) to greater than 150 mils (3.81 mm), from 10 mils (0.254 mm) to 60 mils (1.52 mm), from 20 mils (0.508 mm) to 45 mils (1.143 mm), from 30 mils (0.762 mm) to 45 mils (1.143 mm), from 24 mils to 45 mils, or alternatively from 24 mils to 35 mils, or have any other thickness that allows it to be treated with the reactive silane or solution, but still remain biodegradable, as will become appreciated herein. The thickness of the substrate can be uniform or vary and the substrate can comprise one continuous piece of material or comprise a material with openings such as pores, apertures, or holes disposed therein. Furthermore, the substrate may comprise a single flat substrate (such as a single flat piece of paper) or may comprise a folded, assembled or otherwise manufactured substrate (such as a box or envelope). For example, the substrate can comprise multiple substrates glued, rolled or woven together or can comprise varying geometries such as corrugated cardboard. In addition, the substrates can comprise a subset component of a larger substrate such as when the substrate is combined with plastics, fabrics, non-woven materials and/or glass. It should be appreciated that substrates may thereby embody a variety of different materials, shapes and configurations and should not be limited to the exemplary embodiments expressly listed herein.

Furthermore, as will become better appreciated herein, the substrate can be provided in an environment with a controlled temperature. For example, the substrate can be provided at a temperature ranging from −40° C. to 200° C., alternatively 10° C. to 80° C., or alternatively 22° C. to 25° C.

In the method described herein, the substrate is treated with a reactive silane. The reactive silane may penetrate the substrate as one or more liquids to render the substrate hydrophobic. Alternatively, the reactive silane may penetrate the substrate as one or more vapors. When a plurality of reactive silanes is used, the plurality of reactive silanes comprises at least a first reactive silane and a second reactive silane different from the first reactive silane. The phrase “different from” as used herein means two non-identical reactive silanes so that the substrate is treated with more than one reactive silane. For purposes of this application, a ‘reactive silane’ is defined as a silicon-based monomer or oligomer that contains functionality that can react with water, the —OH groups on the substrates (e.g., cellulosic substrates) and/or sizing agents or additional additives applied to the substrates as appreciated herein.

Examples of suitable reactive silanes include a hydrocarbonoxysilane, an aminofunctional alkoxysilane, and a combination thereof.

The hydrocarbonoxysilane may have formula: Rₐ¹SiR⁴₍₄₋ₐ₎, where R¹ and subscript a are as described above, and each R⁴ is independently selected from an alkoxy group, an alkenyloxy group such as propenoxy or butenoxy, a phenoxy group, a benzyloxy group, and an aryloxy group having a polycyclic aromatic ring.

The hydrocarbonoxysilane may be an alkoxysilane. Suitable alkoxysilanes include phenyltrimethoxysilane, propyltriethoxysilane, triethylorthosilicate, octyltriethoxysilane, and combinations thereof. Other exemplary alkoxysilanes include CH₃Si(OCH₃)₃, CH₃Si(OC₂H₅)₃, CH₃Si(OCH(CH₃)₂)₃, CH₃CH₂ Si(OCH₃)₃, CH₃CH₂Si(OC₂ H₅)₃, CH₃CH₂Si(OCH(CH₃)₂)₃, C₃H₆Si(OCH₃)₃, C₃H₆Si(OC₂H₅)₃, C₃H₆Si(OCH(CH₃)₂)₃, C₄H₉Si(OCH₃)₃, C₄H₉Si(OC₂H₅)₃, C₄H₉Si(OCH(CH₃)₂)₃, C₅H₁₁Si(OCH₃)₃, C₅H₁₁Si(OC₂H₅)₃, C₅H₁₁Si(OCH(CH₃)₂)₃, C₆H₁₃Si(OCH₃)₃, C₆H₁₃Si(OC₂H₅)₃, C₆H₁₃Si(OCH(CH₃)₂)₃, and a combination thereof. Other suitable alkoxysilanes include methyltri-n-propoxysilane, methyltri-i-propoxysilane, methyltri-n-butoxysilane, methyltri-i-butoxysilane, methyltri-sec-butoxysilane, methyltri-t-butoxysilane, ethyltri-n-propoxysilane, ethyltri-i-propoxysilane, ethyltri-n-butoxysilane, ethyltri-i-butoxysilane, ethyltri-t-butoxysilane, n-propyltrimethoxysilane, n-propyltriethoxysilane, isopropyltrimethoxysilane, n-butyltrimethoxysilane, isobutyltrimethoxysilane, isobutyltriethoxysilane, n-octyltrimethoxysilane, n-octyltriethoxysilane, iso-octyltrimethoxysilane, chloromethyltrimethoxysilane, chloromethyltriethoxysilane, chloroethyltrimethoxysilane, chloroethyltriethoxysilane, chloropropyltrimethoxysilane, chloropropyltrimethoxysilane, trifluoropropyltrimethoxysilane, trifluoropropyltriethoxysilane, trifluoropropyltri-n-propoxysilane, trifluoropropyltri-i-propoxysilane, trifluoropropyltri-n-butoxysilane, trifluoropropyltri-t-butoxysilane, trifluoropropylmethyldimethoxysilane, methyldiemthoxyethoxysilane, methyldimethoxy-n-propoxysilane, methyldimethoxy-i-propoxysilane, methyldimethoxy-n-butoxysilane, methyldimethoxy-t-butoxysilane, methyldiethoxy-n-propoxysilane, methyldiethoxy-i-propoxysilane, methyldiethoxy-n-butoxysilane, and methldiethoxy-t-butoxysilane, and combinations thereof. Examples of alkenyl trialkoxysilanes include vinyltrimethoxysilane, vinyltriethoxysilane, vinyltri-isopropoxysilane, allyltrimethoxysilane, allyltriethoxysilane, hexenyltrimethoxysilane, hexenyltriethoxysilane, and combinations thereof. Examples of dialkyldialkoxysilanes that can be used include dimethyldimethoxysilane, dimethyldiethoxysilane, ethylmethyldimethoxysilane, ethylmethyldiethoxysilane, isobutylmethyldimethoxysilane, isobutylmethyldiethoxysilane, and combinations thereof. Examples of trialkylalkoxysilanes that can be used include trimethylmethoxysilane, tri-n-propylmethoxysilane, trimethylethoxysilane, triethylethoxysilane, tri-n-propylmethoxysilane, trimethylethoxysilane, triethylethoxysilane, tri-n-propylethoxysilane, tri-i-propylethoxysilane, tri-n-butylethoxysilane, tetramethoxysilane, tetraethoxysilane, tetra-n-propoxysilane, tetra-i-propoxysilane, tetra-n-butoxysilane, tetra-t-butoxysilane, phenyldimethylmethoxysilane, phenylethylmethylmethoxysilane, diphenylmethylmethoxysilane, triphenylmethoxysilane, triphenylethoxysilane, phenylethyldimethoxysilane, phenylethyldiethoxysilane, phenylmethyldimethoxysilane, phenylmethyldiethoxysilane, phenylmethoxydiethoxysilane, phenyltrimethoxysilane, phenyltrimethoxysilane, phenylmethyltrimethoxysilane, vinyldimethylmethoxysilane, vinyldimethylethoxysilane, vinylmethyldimethoxysilane, vinylmethyldiethoxysilane, vinylphenyldiethoxysilane, triallylethoxysilane, diallylmethylethoxysilane, allyldimethylethoxysilane, and combinations thereof.

Alternatively, the reactive silane may be an acyloxysilane such as an acetoxysilane.

Exemplary acetoxysilanes include, but are not limited to, tetraacetoxysilane, methyltriacetoxysilane, ethyltriacetoxysilane, vinyltriacetoxysilane, propyltriacetoxysilane, butyltriacetoxysilane, phenyltriacetoxysilane, octyltriacetoxysilane, dimethyldiacetoxysilane, phenylmethyldiacetoxysilane, vinylmethyldiacetoxysilane, diphenyldiacetoxysilane, tetraacetoxysilane, and combinations thereof.

Examples of reactive silanes containing both alkoxy and acetoxy groups that may be used herein include methyldiacetoxymethoxysilane, methylacetoxydimethoxysilane, vinyldiacetoxymethoxysilane, vinylacetoxydimethoxysilane, methyldiacetoxyethoxysilane, metylacetoxydiethoxysilane, and combinations thereof.

Aminofunctional alkoxysilanes are exemplified by H₂N(CH₂)₂Si(OCH₃)₃, H₂N(CH₂)₂Si(OCH₂CH₃)₃, H₂N(CH₂)₃ Si(OCH₃)₃, H₂N(CH₂)₃ Si(OCH₂CH₃)₃, CH₃NH(CH₂)₃Si(OCH₃)₃, CH₃NH(CH₂)₃Si(OCH₂CH₃)₃, CH₃NH(CH₂)₅Si(OCH₃)₃, CH₃NH(CH₂)₅Si(OCH₂CH₃)₃, H₂N(CH₂)₂NH(CH₂)₃Si(OCH₃)₃, H₂N(CH₂)₂NH(CH₂)₃ Si(OCH₂CH₃)₃, CH₃NH(CH₂)₂NH(CH₂)₃ Si(OCH₃)₃, CH₃NH(CH₂)₂NH(CH₂)₃Si(OCH₂CH₃)₃, C₄H₉NH(CH₂)₂NH(CH₂)₃Si(OCH₃)₃, C₄H₉NH(CH₂)₂NH(CH₂)₃Si(OCH₂CH₃)₃, H₂N(CH₂)₂SiCH₃(OCH₃)₂, H₂N(CH₂)₂SiCH₃(OCH₂CH₃)₂, H₂N(CH₂)₃SiCH₃(OCH₃)₂, H₂N(CH₂)₃SiCH₃(OCH₂CH₃)₂, CH₃NH(CH₂)₃SiCH₃(OCH₃)₂, CH₃NH(CH₂)₃SiCH₃(OCH₂CH₃)₂, CH₃NH(CH₂)₅SiCH₃(OCH₃)₂, CH₃NH(CH₂)₅SiCH₃(OCH₂CH₃)₂, H₂N(CH₂)₂NH(CH₂)₃SiCH₃(OCH₃)₂, H₂N(CH₂)₂NH(CH₂)₃SiCH₃ (OCH₂CH₃)₂, CH₃NH(CH₂)₂NH(CH₂)₃SiCH₃ (OCH₃)₂, CH₃NH(CH₂)₂NH(CH₂)₃SiCH₃ (OCH₂CH₃)₂, C₄H₉NH(CH₂)₂NH(CH₂)₃SiCH₃ (OCH₃)₂, C₄H₉NH(CH₂)₂NH(CH₂)₃SiCH₃(OCH₂CH₃)₂, and a combination thereof.

Other reactive silanes suitable for use herein comprise silazanes such as hexamethyldisilazane.

Other reactive silanes suitable for use herein comprise oximosilanes and/or ketoximosilanes. Suitable oximosilanes include alkoxytrioximosilanes such as methoxytrioximosilane, ethoxytrioximosilane, and propoxytrioximosilane; or alkenyltrioximosilanes such as propenyltrioximosilane or butenyltrioximosilane; alkenylalkyldioximosilanes such as vinyl methyl dioximosilane, vinyl ethyldioximosilane, vinyl methyldioximosilane, or vinylethyldioximosilane; or combinations thereof.

Suitable ketoximosilanes include methyl tris(dimethylketoximo)silane, methyl tris(methylethylketoximo)silane, methyl tris(methylpropylketoximo)silane, methyl tris(methylisobutylketoximo)silane, ethyl tris(dimethylketoximo)silane, ethyl tris(methylethylketoximo)silane, ethyl tris(methylpropylketoximo)silane, ethyl tris(methylisobutylketoximo)silane, vinyl tris(dimethylketoximo)silane, vinyl tris(methylethylketoximo)silane, vinyl tris(methylpropylketoximo)silane, vinyl tris(methylisobutylketoximo)silane, tetrakis(dimethylketoximo)silane, tetrakis(methylethylketoximo)silane, tetrakis(methylpropylketoximo)silane, tetrakis(methylisobutylketoximo)silane, methylbis(dimethylketoximo)silane, methylbis(cyclohexylketoximo)silane, triethoxy(ethylmethylketoxime)silane, diethoxydi(ethylmethylketoxime)silane, ethoxytri(ethylmethylketoxime)silane, methylvinylbis(methylisobutylketoximo)silane, or a combination thereof.

The reactive silane may be applied to the substrate in a vapor or liquid form. Alternatively, the reactive silane may be applied to the substrate as one or more liquids. Specifically, each reactive silane (e.g., a first reactive silane and any additional reactive silanes) can be applied to the substrate as a liquid, either alone or in combination, with other reactive silanes. As used herein, liquid refers to a fluid material having no fixed shape. In one embodiment, each reactive silane, alone or in combination, can comprise a liquid itself. In another embodiment, each reactive silane can be provided in a solution (where at least the first reactive silane is combined with a solvent prior to treatment of the substrate) to create or maintain a liquid state. As used herein, “solution” comprises any combination of a) one or more reactive silanes and b) one or more other ingredients in a liquid state. The other ingredient may be a solvent, a surfactant, or a combination thereof. In such an embodiment, the reactive silane may originally comprise any form such that it combines with the other ingredient to form a liquid solution. The surfactant useful herein is not critical and any of well-known nonionic, cationic and anionic surfactants may be useful. Examples include nonionic surfactants such as polyoxyethylene alkyl ethers, polyoxyethylene alkyl phenyl ethers, polyoxyethylene carboxylate, sorbitan fatty acid esters, polyoxyethylene sorbitan fatty acid esters, and polyether-modified silicones; cationic surfactants such as alkyltrimethylammonium chloride and alkylbenzylammonium chloride; anionic surfactants such as alkyl or alkylallyl sulfates, alkyl or alkylallyl sulfonates, and dialkyl sulfosuccinates; and ampholytic surfactants such as amino acid and betaine type surfactants. Suitable surfactants such as alkylethoxylates are commercially available. Other suitable surfactants include silicone polyethers, which are commercially available from Dow Corning Corporation of Midland, Mich., U.S.A. Other suitable surfactants include fluorinated hydrocarbon surfactants, fluorosilicone surfactants, alkyl and/or aryl quaternary ammonium salts, polypropyleneoxide/polyethyleneoxide copolymers such as PLURONICS® from BASF, or alkyl sulfonates.

In yet another embodiment, a plurality of reactive silanes can be provided in a single solution (e.g., where the first reactive silane and the second reactive silane are combined with the other ingredient before treatment of the substrate). The plurality of reactive silanes, either alone or in any combination, may thereby comprise a liquid or comprise any other state that combines with another ingredient to comprise a liquid so that the reactive silanes are applied to the substrate as one or more liquids. The various reactive silanes may therefore be applied as one or more liquids simultaneously, sequentially or in any combination thereof onto the substrate.

Thus, in one embodiment, a reactive silane solution can be produced by combining at least the first reactive silane (and any additional reactive silanes) with a solvent. A solvent is defined as a substance that will either dissolve the reactive silane to form a liquid solution or substance that provides a stable emulsion or dispersion of reactive silane that maintains uniformity for sufficient time to allow penetration of the substrate. Appropriate solvents can be non-polar such as non-functional silanes (i.e., silanes that do not contain a reactive functionality such as tetramethylsilane), silicones, alkyl hydrocarbons, aromatic hydrocarbons, or hydrocarbons possessing both alkyl and aromatic groups; polar solvents from a number of chemical classes such as ethers, ketones, esters, thioethers, halohydrocarbons; and combinations thereof. Specific nonlimiting examples of appropriate solvents include isopentane, pentane, hexane, heptane, petroleum ether, ligroin, benzene, toluene, xylene, naphthalene, α- and/or β-methylnaphthalene, diethylether, tetrahydrofuran, dioxane, methyl-t-butylether, acetone, methylethylketone, methylisobutylketone, methylacetate, ethylacetate, butylacetate, dimethylthioether, diethylthioether, dipropylthioether, dibutylthioether, dichloromethane, chloroform, chlorobenzene, tetramethylsilane, tetraethylsilane, hexamethyldisiloxane, octamethyltrisiloxane, hexamethylcyclotrisiloxane, octamethylcyclotetrasiloxane, and decamethylcyclopentasiloxane. For example, in one specific embodiment, the solvent comprises a hydrocarbon such as pentane, hexane or heptane. In another embodiment, the solvent comprises a polar solvent such as acetone. Other exemplary solvents include toluene, naphthalene, isododecane, petroleum ether, tetrahydrofuran (THF) or silicones. The reactive silane and the solvent can be combined to produce a solution through any available mixing mechanism. The reactive silane can be either miscible or dispersible with the solvent to allow for a uniform solution, emulsion, or dispersion.

Alternatively, the solvent may comprise water. Water alone may be used as the solvent, or water may be used in combination with one or more other solvent(s) described above. Alternatively, in one embodiment, the reactive silane may be combined with water to precondense and/or prehydrolyze the reactive silane before penetrating the substrate. One skilled in the art would recognize that the amount of water and the conditions such as temperature and pH for this precondensation and/or prehydrolysis step are such that prepolymers may form. For purposes of this application, the term ‘prepolymers’ refers to molecules, which are reaction products of the reactive silane and water, but which are capable of penetrating the substrate and thereafter further reacting to form the silicone resin in the interstitial spaces of the substrate. Prepolymers may be, for example, silanol functional compounds or oligomers of the reactive silane. One skilled in the art would recognize that the method described herein using the reactive silane may alternatively use the prepolymer in addition to, or instead of, the reactive silane.

When a solution is used, the reactive silane will comprise a certain weight percent of the solution. The weight percent specifically refers to the weight of the reactive silanes (e.g., when a plurality of reactive silanes is used, the first reactive silane, the second reactive silane and any additional reactive silanes) with respect to the overall weight of solution (including any solvents or other ingredients used therein). Exemplary ranges of the amount of reactive silane in the solution include from greater than 0% to 40%, or alternatively from greater than 0% to 5%, alternatively from 5% to 10%, alternatively from 10% to 15%, alternatively from 15% to 20%, alternatively from 20% to 25%, alternatively from 25% to 30%, alternatively from 30% to 35%, or alternatively from 35% to 40%. As noted earlier, these ranges are intended to be exemplary only and not limiting on the disclosure. Accordingly, other embodiments may incorporate an alternative weight percent of the reactive silane in the solution even though not explicitly stated herein.

Once the reactive silane is provided (either separately, as a solution, or combinations thereof), the substrate is treated with the reactive silane to render the substrate hydrophobic. The term “treated” (and its variants such as “treating,” “treat,” “treats,” and “treatment”) means applying the reactive silane to the substrate in an appropriate environment for a sufficient amount of time for the reactive silane to penetrate the substrate and react to form a resin. The term “penetrate” (and its variants such as “penetrating,” “penetration,” “penetrated,” and “penetrates”) means that the reactive silane enters some or all of the interstitial spaces of the substrate, and the reactive silane does not merely form a surface coating on the substrate. Without intending to be bound by a particular theory or mechanism, it is thought that the reactive silane can react with the —OH functionality of the substrate, the water within the substrate and/or other sizing agents or additional additives therein to form the resin. The resin refers to any product of the reaction between the reactive silane and the —OH functionality of the substrate, the water within the substrate and/or other sizing agents or additional additives therein; which renders the substrate hydrophobic. Specifically, the reactive silanes capable of forming two or more bonds can react with the hydroxyl groups distributed along the cellulose chains of a cellulosic substrate and/or the water contained therein to form a resin disposed throughout the interstitial spaces of the cellulosic substrate and anchored to the cellulose chains of the cellulosic substrate. Where the reactive silane reacts with the water in the substrate, the reaction can produce an HX product (where X is the reactive atom or group from the reactive silane) and a silanol. The silanol may then further react with a reactive silane or another silanol to produce the resin. The different reaction mechanisms can continue substantially throughout the matrix of the substrate, thereby treating a part of the volume, or the entire volume, of a substrate of appropriate thickness. When the reactive silane penetrates all the way through the thickness of the substrate, the entire volume of the substrate can be treated.

Penetrating the substrate with the reactive silane can be achieved in a variety of ways. For example, without intending to be limited to the exemplary embodiments expressly disclosed herein, the reactive silane or a solution can be applied to the substrate by being dropped onto the substrate (e.g., through a nozzle or die), by being sprayed (e.g., through a nozzle) onto one or more surfaces of the substrate, by being poured onto the substrate, by immersion (e.g., by passing the substrate through a contained amount of the reactive silane compound or solution), by dipping the substrate into the reactive silane compound or solution), or by any other method that can coat, soak, or otherwise allow the reactive silane to come into physical contact with the substrate and enter interstitial spaces in the substrate. In one embodiment, where reactive silanes are applied separately (e.g., not as a single solution), the first reactive silane, the second reactive silane, and any additional reactive silanes can be applied simultaneously or sequentially to the substrate or in any other repeating or alternating order. Alternatively, where a combination of separate reactive silanes and solutions are used, the reactive silanes and solutions may also be applied simultaneously or sequentially or in any other repeating or alternating order.

Alternatively, without intending to be limited to the exemplary embodiments expressly disclosed herein, the reactive silane or a solution can be applied to the substrate in vapor form by passing the substrate through a chamber containing vapor of the reactive silane or introducing a reactive silane in vapor form directly onto the surface of the substrate.

For example, in one embodiment, where the substrate comprises a roll of paper, the paper can be unrolled at a controlled velocity and passed through a treatment area where the reactive silane is dropped onto the top surface of the paper. The velocity of the paper can depend in part on the thickness of the paper and/or the amount of reactive silane to be applied and can range from 1 feet/minute (ft./min.) to 3000 ft./min., from 10 ft./min. to 1000 ft./min. or 20 ft./min to 500 ft./min. Within the treatment area one or more nozzles may drop a solution onto one or both surfaces of the substrate so that one or both surfaces of the substrate is covered with the solution.

The substrate treated with the reactive silane can then rest, travel or experience additional treatments to allow the reactive silane to react with the substrate and/or the water therein. For example, to allow for an adequate amount of time for reaction, the substrate may be stored in a heated, cooled and/or humidity-controlled chamber and allowed to remain for an adequate residence time, or may alternatively travel about a specified path wherein the length of the path is adjusted such that the substrate traverses the specified path in an amount of time adequate for the reaction to occur.

The method may further comprise exposing the treated substrate to a basic compound (such as ammonia gas) after the reactive silane is applied to the substrate. The term ‘basic compound’ refers to any chemical compound that has the ability to react with and neutralize the HX compound produced upon reaction of the reactive silane. For example, in one embodiment, the reactive silane may be applied to the substrate and passed through a chamber containing ammonia gas such that the substrate is exposed to the ammonia gas. Without intending to be bound by a particular theory, the basic compound may both neutralize acids generated from applying the reactive silane to the substrate and further drive the reaction between the reactive silane and water, and/or the substrate, to completion. Other non-limiting examples of useful basic compounds include both organic and inorganic bases such as hydroxides of alkali metals or amines. Alternatively, any other base and/or condensation catalyst may be used in whole or in part in place of the ammonia and delivered as a gas, a liquid, or in solution. In this context, the term “condensation catalyst” refers to any catalyst that can affect reaction between two silanol groups or a silanol group and a group formed in situ as a result of the reaction of the reactive silane with an —OH group (e.g., bonded to cellulose) to produce a siloxane linkage. In yet another embodiment, the substrate may be exposed to the basic compound before, simultaneous with or after the reactive silane is applied, or in combinations thereof.

To increase the rate of reaction, the substrate can also optionally be heated and/or dried after the reactive silane is applied to produce the resin in the substrate. For example, the substrate can pass through a drying chamber in which heat is applied to the substrate. The temperature of the drying chamber will depend on the type of substrate and its residence time therein, however, the temperature in the chamber may comprise a temperature in excess of 200° C. Alternatively, the temperature can vary depending on factors including the type of substrate, the speed in which the substrate passes through the drying chamber, the thickness of the substrate, and/or the amount of the reactive silane applied to the substrate. Alternatively, the temperature provided to the substrate may be sufficient to heat the substrate to 200° C. upon its exit from the drying chamber.

Once the substrate is treated to render it hydrophobic, the hydrophobic substrate will comprise the resin from the reaction between the reactive silane and the cellulosic substrate and/or the water within the substrate as discussed above. The resin can comprise anywhere from greater than 0% of the hydrophobic substrate to less than 1% of the hydrophobic substrate. The percent refers to the weight of the resin with respect to the overall weight of both the substrate and the resin. Other ranges of the amount of resin in the substrate include 0.01% to 0.99%, alternatively, 0.1% to 0.9%, alternatively 0.3% to 0.8%, and alternatively 0.3% to 0.5%. Without wishing to be bound by theory, it is thought that an amount of resin in the substrate less than that described above may provide insufficient hydrophobicity for the applications described herein, such as packaging material and disposable food service articles. At higher amounts of resin than that described above, it may be more difficult to compost the substrate at the end of its useful life.

Without intending to be bound by a particular theory, it is thought that that by mixing different reactive silanes in varying ratios and amounts to form a plurality of reactive silanes, the deposition efficiencies of the reactive silanes may increase allowing for the methods of rendering substrates hydrophobic to become more efficient by achieving greater reactive silane deposition during treatment.

### EXAMPLES

The following examples are included to demonstrate the invention to one of ordinary skill However, those of ordinary skill in the art should, in light of the present disclosure, appreciate that many changes can be made in the specific embodiments which are disclosed and still obtain a like or similar result without departing from the spirit and scope of the invention.

### Reference Example 1—Disintegration Testing

The disintegration of paperboard was evaluated during 12 weeks of composting. The test items of paperboard were placed in slide frames and added to biowaste in an insulated composting bin. The biowaste was a mixture of fresh vegetable, garden and fruit waste (VGF) and structured material. The biowaste was derived from the organic fraction of municipal solid waste, obtained from the waste treatment plant of Schendelbeke, Belgium. The biowaste had a moisture content and a volatile solids content of more than 50% and a pH above 5. Water was added to the biowaste during the test to ensure a sufficient moisture level. At a start a pH of 6.9 was measured, and after 1.5 week of compositing, the pH increased above 8.5. The maximum temperature during composting ranged from above 60° C. to below 75° C. The daily temperature was above 60° C. during more than 1 week. After 1.5 week of composting, the bin was placed in an incubation room at 45° C. to ensure the daily temperature remained above 40° C. during at least 4 weeks. The daily temperature remained at or above 40° C. for the entire test period. The temperature and exhaust gas were regularly monitored. During composting, the content of the bin was manually turned, weekly during the first month and later on every 2 weeks, at which times samples were visually monitored. During the entire test period, oxygen concentration remained above 10%, which ensured aerobic conditions. This test method was predictive of whether a substrate would pass the test for biodegradability set forth in ASTM Standard D6868-03.

### Reference Example 1—Treatment Procedure, Cobb Sizing Test and Immersion Test, and Strength Evaluation

Unbleached kraft papers (24 pt and 45 pt), which were light brown in color, were treated with various solutions containing a reactive silane in a solvent (either pentane or methylacetate). The papers were drawn through a machine as a moving web where the treatment solution was applied. The line speed was typically 10 feet/ minute to 30 ft/min, and the line speed and flow of the treating solution were adjusted so that complete soak-through of the paper was achieved. The paper was then exposed to sufficient heat and air circulation to remove solvent and volatile silane.

The hydrophobic attributes of the treated papers were then evaluated via the Cobb sizing test and immersion in water for 24 hours. The Cobb sizing test was performed in 2 accordance with the procedure set forth in TAPPI testing method T441 where a 100 cm surface of the paper was exposed to 100 milliliters (mL) of 50° C. deionized water for three minutes. The reported value was the mass (g) of water absorbed per square meter (g/m²) by the treated paper.

The immersion test was conducted by completely immersing 6″×6″ (15.24 cm×15.24 cm) pieces of treated paper in a bath of deionized water for a uniform period of time (e.g., 24 hours) in accordance with TAPPI testing method T491. The uptake of water by the paper was expressed as a percent weight gain. The strength properties of the paper were further evaluated by measuring the tensile strength of 1″ (2.54 cm) wide strips cut from both the machine direction (MD) and cross direction (CD) of the paper as set forth in TAPPI testing method T494. The machine direction refers to the direction in which the fibers in the paper are generally aligned as influenced by the direction of feeding through the machine when the cellulosic substrate is made. The cross direction refers to the direction perpendicular to the direction in which the fibers in the paper generally align.

The dry and wet tear values were evaluated in accordance with the procedure set forth in TAPPI test method T414. Treated papers were soaked in water at 22° C. for one hour before performing measurements to obtain the wet tear values. Strength properties were tested in both the machine direction (MD) and the cross direction (CD). The deposition efficiency was calculated from the amount of reactive silane(s) applied to the cellulosic substrate using the known variables of solution concentration, solution application rate, and paper feed rate. The amount of resin contained in the treated paper was determined by converting the resin to monomeric siloxane units and quantifying such using gas chromatography pursuant to the procedure described in “The Analytical Chemistry of Silicones,” Ed. A. Lee Smith. Chemical Analysis Vol. 112, Wiley-Interscience (ISBN 0-471-51624-4), pp 210-211. The deposition efficiency was then determined by dividing the amount of resin in the paper by the amount of reactive silane(s) applied.

1. A method comprising:
1) penetrating a substrate with a reactive silane; and
2) forming a resin from the reactive silane;
where the product of step 2) is both hydrophobic and biodegradable.

2. The method of claim 1, where the reactive silane is selected from formula (I): Rₐ¹Si(XR_{b}²)₍4−a), where
each R¹ is independently a monovalent hydrocarbon group; i
each X is independently selected from a hydrogen atom, an oxygen atom, a selenium atom, a nitrogen atom, a sulfur atom, a carbon atom, and a phosphorus atom,
each R² is a monovalent organic group,
subscript a has an average value ranging from 0 to 3, and
subscript b has a value matching a remaining valence of group X; 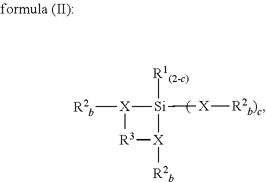
where
R¹, R², X, and subscript b are as described above,
each R³ is a divalent organic group, and
subscript c is 0, 1, or 2; 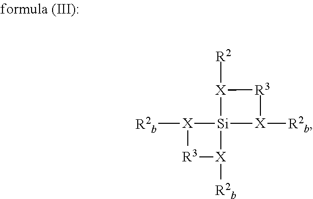
where
R², R³, X, and subscript b are as described above; and
(IV): a combination thereof;
with the proviso that if all instances of X are carbon atoms, then at least one R² is reactive with an —OH group and/or ambient moisture.

3. The method of claim 1, where the product of step 2) is compostable.

4. The method of claim 1, where the product of step 2) meets ASTM D6868-03.

5. The method of claim 1, where the product of step 2) contains less than 1% of the resin.

6. The method of claim 1, further comprising: step 3) exposing the substrate to a basic compound, where the product of step 3) is both hydrophobic and biodegradable.

7. The method of claim 6, where the basic compound comprises an ammonia gas.

8. The method of claim 6, where the product of step 3) is compostable.

9. The method of claim 6, where the product of step 3) meets ASTM D6868-03.

10. The method of claim 6, where the product of step 3) contains less than 1% of the resin.

11. The method of claim 1, where the reactive silane is provided in a solution comprising the reactive silane and one or more additional ingredients.

12. The method of claim 11, where the solution further comprises a solvent.

13. The method of claim 12, where the solvent is pentane, hexane, heptane, or petroleum ether.

14. An article comprising:
a cellulosic substrate; and,
0.01% to 0.99% of a resin, where the resin is produced from treating the cellulosic substrate with a reactive silane, and
the article is both hydrophobic and biodegradable.

15. The article of claim 14, where the reactive silane is selected from formula (I): Rₐ¹Si(XR_{b}²)₍₄₋ₐ₎, where
each R¹ is independently a monovalent hydrocarbon group;
each X is independently selected from a hydrogen atom, an oxygen atom, a selenium atom, a nitrogen atom, a sulfur atom, a carbon atom, and a phosphorus atom,
each R² is a monovalent organic group,
subscript a has an average value ranging from 0 to 3, and
subscript b has a value matching a remaining valence of group X; 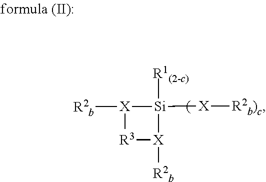
where
R¹, R², X, and subscript b are as described above,
each R³ is a divalent organic group, and
subscript c is 0, 1, or 2; 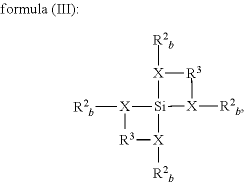
where
R², R³, X, and subscript b are as described above; and
(IV): a combination thereof.

16. The article of claim 14, where the article is compostable.

17. The article of claim 14, where the article meets ASTM D6868-03.

18. The article of claim 14, where the substrate comprises paper, cardboard, boxboard, wood, wood products, wallboard, textiles, starches, cotton or wool.

19. The article of claim 14, where the substrate comprises paper, cardboard or boxboard.

20. The article of claim 14, where the article is a packaging material or a disposable food service article.
